(19) United States
(12) Patent Application Publication
(10) Pub. No.: US 2009/0122446 A1
(43) Pub. Date: May 14, 2009

(54) Data storage tape guiding system

(75) Inventors: Douglas W. Johnson, Stillwater, MN (US); James L. Albrecht, Wahpeton, ND (US); Geoffrey A. Lauinger, Campbell, MN (US); Gregory W. Visich, Woodbury, MN (US)

Correspondence Address: Attention: Eric D. Levinson;Imation Corp., Legal Affairs, P.O. Box 64998, St. Paul, MN, 55164-0898, US

(73) Assignee: Imation Corp.

(21) Appl. No.: 11/983,651

(22) Filed: Nov. 12, 2007

(51) Int. Cl. G11B 15/60; G11B 23/027

(52) U.S. Cl. 360/130.21; 360/132

(57) ABSTRACT

A data storage tape guiding system is configured to guide a data storage tape along a tape path crossing a read/write head. The data storage tape guiding system includes data storage tape supply components and data storage tape take-up components. An entirety of the supply components is disposed on a common first plane on a first side of the read/write head. An entirety of the take-up components is disposed on a common second plane on a second side of the read/write head. The common first plane is different than the common second plane.

### TECHNICAL FIELD

This disclosure relates to data storage tape, and more particularly, to a tape guiding system configured to guide data storage tape during media fabrication, servo recording, data recording, and/or data readout.

### BACKGROUND

Data storage media are commonly employed to store and retrieve data and are available in many forms, such as magnetic tape, magnetic disks, optical tape, optical disks, holographic disks, cards or tapes, and the like. Magnetic tape remains an economical medium for storing large amounts of retrievable data. For example, tape cartridges maintaining large spools of magnetic tape are commonly employed to back up vast stores of data for computing centers, computers or businesses.

Data are typically stored as signals that are magnetically recorded on a surface of the magnetic tape. The data are often organized along “data tracks,” and read/write heads are positioned relative to the data tracks to write data to the tracks or read data from the tracks. Other types of data storage tape include optical tape, magneto-optic tape, holographic tape, and the like.

Data storage capacity on data storage tape increases as the number of data tracks on the data storage tape increases. However, as the number of data tracks increases, the tracks become narrower (e.g., more crowded) on the surface of the data storage tape. An increase in the number of data tracks can make positioning of the read/write head relative to a desired data track more challenging. Proper data storage and recovery necessitates that the read/write head locate each data track, and follow the path of the data track accurately along the surface of the data storage tape. Servo techniques have been developed in order to facilitate precise positioning of the read/write head relative to the data tracks on the data storage tape.

Servo information refers to signals, patterns, or other recorded markings on the data storage tape that are used for tracking purposes. As an example, servo information is recorded on the data storage tape to provide reference points relative to the data track. A servo controller interprets detected servo information and generates position error signals. The position error signals are employed to adjust the lateral position of the read/write head relative to the data tracks so that the read/write head is properly positioned along the data tracks for effective reading and/or writing of the data.

A variety of different servo patterns have been developed, including time-based servo patterns, amplitude-based servo patterns, and other types of servo patterns. Time-based servo patterns typically employ servo marks and time variables that are calculated as the servo marks feed past a head at a constant velocity. Amplitude-based servo patterns typically involve the detection of servo signal amplitudes, which enables identification of head positioning relative to the medium.

With some data storage tape, such as magnetic tape, the servo information is often stored in specialized tracks on the medium called “servo tracks.” Servo tracks serve as references for the servo controller. Conventional servo tracks typically hold no data except for information that is useful to the servo controller to identify positioning of a read/write head relative to the surface of the data storage tape. Alternatively, servo information may be interspersed within the data tracks, e.g., at regular intervals.

In any case, the servo information is typically recorded during media fabrication. Then, the servo information is sensed by one or more servo heads during use of the medium in order to pinpoint location of the data tracks. For example, servo heads may be dedicated heads that read only servo information. Once the servo head locates a particular servo track, one or more data tracks can be located on the medium according to the data track's displacement from the servo track. The servo controller receives detected servo signals from the servo heads, and generates position error signals, which are used to adjust positioning of a read/write head relative to the data tracks.

The ability to properly guide data storage tape during media fabrication, servo recording, data recording and data readout can be a limiting factor in achieving improved track densities on the tape. For example, the ability to record an increased number of servo tracks on the tape can be limited by the ability to properly guide the tape during servo writing. Moreover, the ability to increase the density of servo tracks, and thereby allow for increased density of data tracks, can also be limited by tape guiding limitations. The ability to read the servo patterns, or to record and read out data tracks, presents similar tape guiding challenges.

### SUMMARY

One aspect provides a data storage tape guiding system configured to guide a data storage tape along a tape path crossing a read/write head. The data storage tape guiding system includes data storage tape supply components and data storage tape take-up components. The data storage tape supply components are disposed on a first side of the read/write head, with an entirety of the supply components disposed on a common first plane. The data storage tape take-up components are disposed on a second side of the read/write head, with an entirety of the take-up components disposed on a common second plane. The common first plane is different than the common second plane.

Another aspect provides a data storage tape cartridge insertable into a tape drive having a read/write head. The data storage tape cartridge includes a housing enclosing at least one reel maintaining a length of data storage tape, and a guide system disposed within the housing. The guide system includes data storage tape supply components and data storage tape take-up components. The data storage tape supply components are disposed on a first side of the read/write head, with an entirety of the supply components aligned on a common first plane. The data storage tape take-up components are disposed on a second side of the read/write head, with an entirety of the take-up components aligned on a common second plane that is different than the common first plane. The guide system is configured to direct the data storage tape along a tape path extending from the common first plane, across the read/write head, to the common second plane.

Another aspect provides a magnetic tape system including a magnetic tape, a read/write head configured to read data from and write data to the data storage tape, and a guide system. The guide system includes an entirety of magnetic tape supply components aligned on a first common plane on a first side of the read/write head, and an entirety of magnetic tape take-up components aligned on a second common plane on a second side of the read/write head. The second common plane is different than the first common plane, and the guide system is configured to direct the magnetic tape along a tape path extending from the first common plane, across read/write head, to the second common plane.

### BRIEF DESCRIPTION OF THE DRAWINGS

The accompanying drawings are included to provide a further understanding of embodiments and are incorporated in and constitute a part of this specification. The drawings illustrate embodiments and, together with the description, serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view of a bottom portion of a data storage tape cartridge including a tape guiding system that is insertable into a tape drive having a read/write head according to one embodiment;

FIG. 2 is a front view of components of the tape guiding system shown in FIG. 1 according to one embodiment;

FIG. 3 is a front view of a tape path defined by a data storage tape traversing the components shown in FIG. 2;

FIG. 4 is an exploded perspective view of a tape guiding system including a startup-only rotating guide assembly according to one embodiment;

FIG. 5A is a cross-sectional view of a guide of the startup-only rotating guide assembly shown in FIG. 4;

FIG. 5B is an enlarged view of a radiused flange of the guide shown in FIG. 5A;

FIG. 6 is a perspective view of a tape guiding system according to another embodiment;

FIG. 7A is a perspective view of a double flange guide assembly configured for use with a tape guiding system according to one embodiment;

FIG. 7B is a front view of the double flange guide assembly shown in FIG. 7A; and

FIG. 8 is a front view of a tape path defined by a data storage tape traversing between two double flange guide assemblies as shown in FIG. 7B.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

Embodiments provide a tape guiding system configured to improve guiding of data storage tape. The disclosed tape guiding systems have utility during media fabrication, servo recording, data recording, data readout, or other occasions during which accurate tape guiding is desirable. Aspects of the disclosure relate to data storage tape including magnetic tape, optical tape, holographic tape, magneto-optic tape, or other formats of data storage media.

Embodiments provide a tape guide system configured for use during servo writing that improves the accuracy of recorded servo tracks. The tape guiding system includes supply components disposed on a common first plane, and take-up components disposed on a common second plane, where the common first plane is different than the common second plane. The common planes define respective first and second datum levels. By maintaining two separate and distinct datum levels, a bi-level tape path is defined that reduces tape edge loading.

The reduced tape edge loading is less than would otherwise occur in relatively short tape paths having shear close engagement guides, as employed in some data storage tape cartridges. In some embodiments, guides of the tape guide system are disposed adjacent and near the take-up reel and supply reel and are configured to minimize flange hits. In one embodiment, a separate wrap guide is provided adjacent to the supply components and configured to reduce the possibility of flange hits at a squeeze bearing defined the supply reel and a guide adjacent the supply reel.

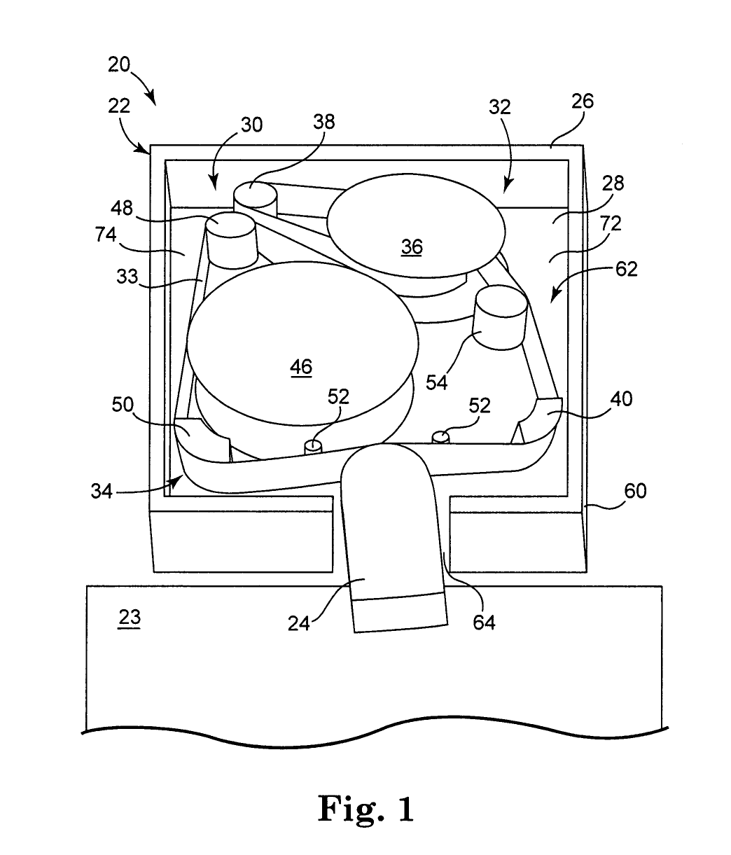

FIG. 1 is a perspective view of a tape system 20 according to one embodiment. The tape system 20 includes a data storage tape cartridge 22 that is insertable into (or engageable with) a tape drive 23 having a read/write head 24. The data storage tape cartridge 22 is configured to store a vast amount of retrievable data. Data is written to and retrieved from components of the data storage tape cartridge 22 by inserting the data storage tape cartridge 22 into the tape drive 23 (simplified for illustrative clarity) and engaging read/write head 24 with data storage tape 33 within the data storage tape cartridge 22.

The data storage tape cartridge 22 includes a housing 26 enclosing a base plate 28 supporting a tape guiding system 30 that is configured for guiding the tape 33. The tape guiding system 30 includes supply components 32 and take-up components 34 disposed on the base plate 28 that combine to define a tape path for the tape 33 as it moves across the read/write head 24. The read/write head 24 is coupled to an actuator that enables the head 24 to move up and down, and the tape guiding system 30 is configured to enable the head 24 to precisely and reproducibly track with the moving tape 33.

In one embodiment, the supply components 32 include a supply reel 36, a first supply guide 38, and a second supply guide 40, and the take-up components 34 include a take-up reel 46, a first take-up guide 48, and a second take-up guide 50. The base plate 28 includes head wrap pins 52 that are configured to wrap the tape 33 about a desired wrap angle, or path, along a curvature of head 24. The tape guide system 30 includes a wrap guide 54 that is configured to minimize flange hits between the tape 33 and flanges of the various supply components 32 during read/write operations.

In one embodiment, the housing 26 includes a lower housing section 60 configured to reciprocally mate with an upper housing section (not shown) to define an enclosure 62. The upper housing section has been removed and is not shown in order to provide an interior view of the enclosure 62. In one embodiment, the housing 26 includes a window 64 that communicates with the enclosure 62, where the window 64 is sized to receive the head 24 when the data storage tape cartridge 22 is inserted into the tape drive 23.

The base plate 28 is fabricated or formed to provide a bi-level plate having a common first plane 72 on which the supply components 32 are positioned and a separate and different common second plane 74 on which the take-up components 34 are positioned. In one embodiment, the base plate 28 is machined from metal to include the bi-level planes 72, 74 and is inserted into and coupled with the lower housing section 60.

In one embodiment, the tape 33 includes magnetic tape of a type commonly known in the art, such as a balanced polyethylene naphthalate-based material coated on one side with a layer of magnetic material dispersed within a suitable binder system and coated on the other side with a conductive material dispersed within a suitable binder system. Acceptable tape is available, for example, from Imation Corp., of Oakdale, Minn. In some configurations, the tape 33 includes a smooth backside tape that has a tendency to stick to guides of a guide system in high humidity conditions. Embodiments of the tape guiding system 30 described herein minimize the sticking of the smooth backside tape to the guides.

The supply reel 36 and the take-up reel 46 generally include a cylindrical hub onto which the tape 33 is wound, and include upper and lower flanges as shown. In one embodiment, the guides 38, 40, 48, 50 include fixed flange guides. In other embodiments, some or all of the guides 38, 40, 48, 50 include flange-less guides. In one embodiment, the guides 38 and 48 are rotating fixed flange guides and the guides 40 and 50 are compliant stationary dual flange guides. In one embodiment, the guides 38 and 48 rotate on start up only (i.e., acceleration of the tape 33) and become static guides when the tape 33 reaches steady state, as further described below.

In general, the guides 38, 40, 48, 50 combine to define the tape path. In one embodiment, the guides 38, 40, 48, 50 include metal or plastic guides, and one preferred material for guides 38, 40, 48, 50 includes stainless steel. Suitable guides include hydrodynamic air bearing guides or hydrostatic air bearing guides. Hydrodynamic air bearing guides enable the tape 33 to “fly” over the tape path surfaces of the guides as the motion of the tape 33 entrains air between the guide(s) and the tape 33. Hydrostatic air bearing guides enable the tape 33 to fly over the guides as air is introduced by an external source and forced between the guides and the tape 33. In other embodiments, the guides include roller bearings and rollers configured to roll as the tape 33 moves over the guides.

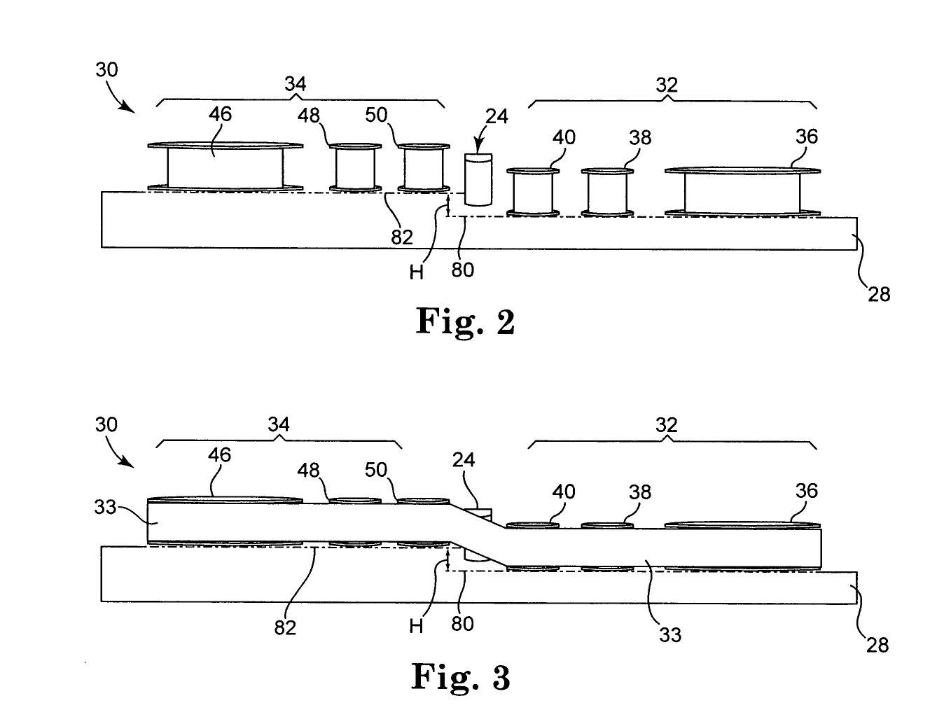

FIG. 2 is a front view of the tape guiding system 30 according to one embodiment. In one embodiment, the supply components 32 are disposed on a common first plane 80 of the base plate 28, and the take-up components 34 are disposed on a common second plane 82 of the base plate 28. The common first plane 80 is different than the common second plane 82, such that the planes 80, 82 are offset relative to each other by a distance H.

For example, in one embodiment the supply reel 36 and the first and second supply guides 38, 40 are disposed on the common first plane 80 on one side of read/write head 24, and the take-up components 34 including the take-up reel 46 and the first and second take-up guides 48, 50 are disposed on the common second plane 82 on an opposite side of read/write head 24. The read/write head 24 is configured to move laterally up and down relative to a neutral reference plane or a zero plane. In one embodiment, the common first plane 80 is disposed below the zero plane of read/write head 24, and common second plane 82 is disposed above the zero plane of read/write head 24. Other configurations are also acceptable, such as the common first plane 80 being disposed above the common second plane 82.

The read/write head 24 is coupled to an actuator that is configured to move the head 24 up and down relative to FIG. 2. The guide system 30 is configured so the common first plane 80 is different than common second plane 82 such that the head 24 has less than about 100 nanometers of residual tracking error when tracking or following a servo track pattern formed on the tape 33 (FIG. 1). In one embodiment, the common first plane 80 is different from common second plane 82 by a distance of between about 0.002-0.010 inches, and preferably the common first plane 80 is different from common second plane 82 by a distance of about 0.006 inches such that the dimension H is about 0.006 inches. To this end, the dimension H is between about 0.002-0.010 inches, although values for the height H are also acceptable.

In one embodiment, guides 38, 40, 48, 50 are fixed flange guides, where the guides 38 and 48 are back or idler guides and guides 40, 50 are stationary front guides. It has been surprisingly discovered that disposing the supply guides 38, 40 on the common first plane 80 and disposing the take-up guides 48, 50 on the offset common second plane 82 reduces edge loading on the tape 33 that would otherwise occur with staggered configurations of close engagement guides. In addition, the configuration of guides 38, 40, 48, 50 illustrated in FIGS. 1 and 2 have been surprisingly discovered to minimize flange hits between the tape 33 and the flanges on the guides 38, 40, 48, 50.

FIG. 3 is a front view of a tape path defined by the tape 33 as it traverses between supply reel 36 to take-up reel 46 according to one embodiment. The supply components 32 are shown on a right side of the head 24 in FIG. 3. It is to be understood that the supply components 32 could be positioned on a left side of the head 24 having their position switched with the take-up components 34. In any regard, the tape 33 defines a tape path extending between the supply reel 36 to the take-up reel 46 as it traverses guides 38, 40, 48, 50 in a manner that defines a bi-level tape path having a shear effect across read/write head 24.

In one embodiment, supply components 32 are disposed on the common first plane 80 at a first datum of about −0.003 inches relative to a neutral or mid-plane of the base plate 28, and take-up components 34 are disposed on the common second plane 82 offset on a second datum of about +0.003 inches relative to a neutral or mid-plane of the base plate 28 such that height H is 0.006 inches. In other embodiments, supply components 32 are disposed above take-up components 34. Other configurations for an offset distance H are also acceptable.

The path defined by the tape 33 in FIG. 3 travels level along the first datum defined by the position of the supply components 32 on the common first plane 80, shears across the head 24, and travels level along the second datum defined by the position of the take-up components 34 on the common second plane 82. The path of the tape 33 thus travels along a first linear level and shears across the head 24 to the next second linear level. In contrast, the known close engagement guides employed with tape would travel along a path starting at a zero datum level (0) from the supply spool downward (−) to a first supply guide, and upward (+) to shear across a read/write head to a first elevated take-up guide before deflecting downward (−) to return to a zero datum (0) at the take-up spool. It has been surprisingly discovered that the bi-level tape path described herein has a significantly reduced edge loading on the tape 33 as compared to the conventional (0−+0) tape path that returns to zero at the spools, especially as it applies to short tape path cartridges.

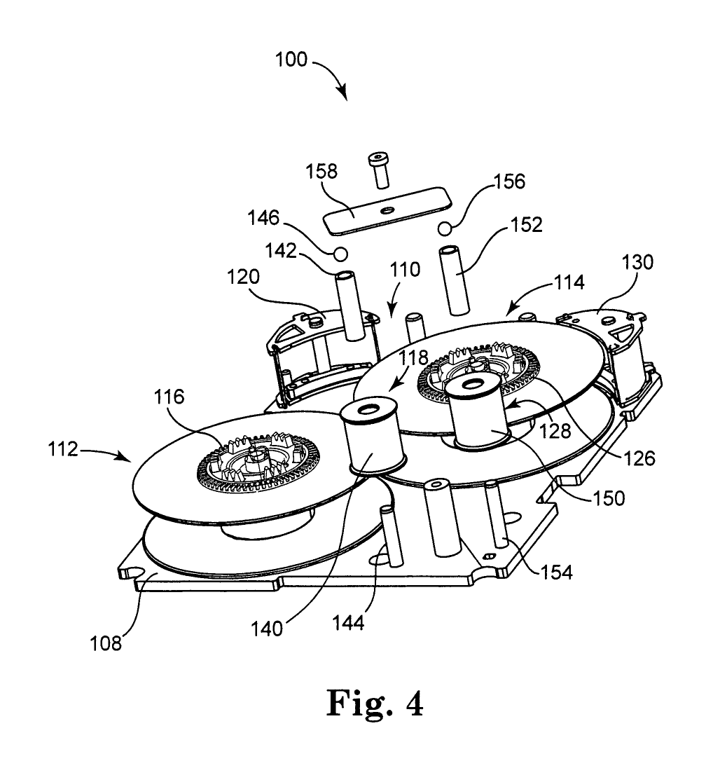

FIG. 4 is an exploded perspective view of a tape system 100 according to another embodiment. The tape system 100 includes components that are configured for insertion into a data storage tape cartridge or other media storage device. In this regard, housing sections configured to enclose the components of the tape system 100 are not shown in FIG. 4 for ease of illustration. In one embodiment, the tape system 100 includes a data storage tape (not shown but similar to the tape 33 above) that is guided through a path by a guide system 110 coupled to a base plate 108. The guide system 110 guides the data storage tape during media fabrication, servo recording, data recording, and/or data readout.

In one embodiment, the guide system 110 includes supply components 112 and take-up components 114 coupled to a base plate 108. In one embodiment, the supply components 112 include a supply reel 116, a first supply guide assembly 118, and a second supply guide 120, and the take-up components 114 include a take-up reel 126, a first take-up guide assembly 128, and a second take-up guide 130. The guide assemblies 118, 128 provide back guides or idler guides, and the guides 120, 130 provide front guides.

The base plate 108 is similar to the base plate 28 (FIGS. 1-3) and guides 120, 130 are similar to the fixed flange guides 40, 50 described above. In one embodiment, the base plate 108 is fabricated or otherwise configured to define a common first plane onto which the supply components 112 are disposed, and a common second plane onto which the take-up components 114 are disposed. As described above, it is desirable that the common first plane is different than the common second plane such that the base plate 108 provides a bi-level tape path having an offset distance between the supply components 112 and the take-up components 114.

In one embodiment, the guides 120 and 130 are fixed-flange compliant stationary guides, and the guide assembly 118 and the guide assembly 128 include startup-only rotating guides 140, 150, respectively, that are configured to rotate at the startup of the motion of the tape and stop rotating and become a static flying tape guide at the steady state operating speed of the tape. In some tape systems, the tape tension is relatively high (i.e., the tape is tightly wound) and a backside of the tape is relatively smooth such that upon startup of the tape, a stationary guide will potentially and undesirably distort or tear the storage tape. Embodiments described below provide a startup-only rotating guide member that is configured to rotate at startup to reduce the rate of change of the startup tension on the guides, and thus minimize the likelihood that the tape will be damaged.

In one embodiment, the guide assembly 118 includes a guide 140, a sleeve 142 that is pressed into the guide 140 and configured to rotate on a pin 144 that is coupled to the base plate 108, and a bearing 146. In one embodiment, the guide assembly 128 likewise includes a guide 150, a sleeve 152 that is pressed into the guide 150 and configured to rotate on a pin 154 coupled to the base plate 108, and a bearing 156. In one embodiment, a retainer plate 158 is provided that couples to a top portion of the guide assemblies 118, 128 to provide tension adjustment for the rotatable guides 140, 150.

As noted, the tape tension at startup can be large, and is typically sufficient to rotate the guides 140, 150. After initiation of movement of the tape, the tape begins to “fly” and the tape tension decreases. In one embodiment, the retainer plate 158 and the sleeves 142, 152 combine to provide a drag force component that is greater than the force of the flying tape on the guides 140, 150. In this manner, the retainer plate 158 and the sleeves 142, 152 decelerate the guides 140, 150 and the guides 140, 150 cease rotation. Thus, the guides 140, 150 are configured to rotate on startup and stop rotating and become a static when the tape is moving at operational speeds (e.g., between about 1-5 meters per second). In one embodiment, the wrap guide 54 is configured as a rotating/static guide assembly similar to the guide assemblies 118, 128.

Suitable materials for the guides 140, 150 include metal or plastic. In one embodiment, the guides 140, 150 are machined from stainless steel, although other metals are also acceptable. Suitable materials for the sleeves 142, 152 include solid metal or coated metal surfaces. In one embodiment, the sleeves 142, 152 are formed from a phosphorus bronze metal and are press-fit into a respective one of the guides 140, 150. In one embodiment, the bearings 146, 156 are steel balls that enable the sleeves 142, 152 to rotate on the pins 144, 154, respectively, and allow for precise height adjustment of the sleeves 142, 152 relative to the plate 108.

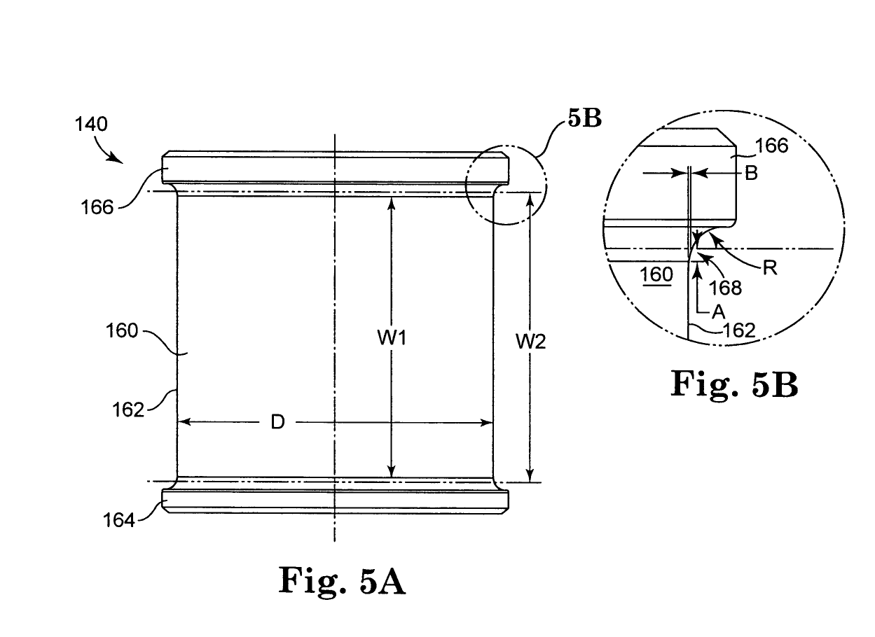

FIG. 5A is a side view of the guide 140 shown in FIG. 4. Guide 150 (FIG. 4) is similar. In one embodiment, the guide 140 includes a hub 160 that defines a tape winding surface 162, a first flange 164, and a second flange 166 opposite the first flange 164. In one embodiment, the hub 160 and the flanges 164, 166 are integrally formed by machining, molding, or other suitable processes. In one embodiment, the hub 160 is configured to have a diameter D and a width W1. In one embodiment, the flanges 164, 166 include a radius that blends with the hub 160 where the blended radius extends from the tape winding surface 162 to a width of W2.

In one embodiment, the diameter D of the hub 160 is between about 0.25-2.0 inches, and preferably the diameter D is about 0.5 inches. In one embodiment, the width W1 of the tape winding surface 162 is between about 0.25-2.0 inches, and preferably the width W1 of the tape winding surface is about 0.4840 inches. In one embodiment, the width W2 of the extended tape winding surface 162 is about 0.4980 inches, although other dimensions are also acceptable.

FIG. 5B is an enlarged view of the flange 166 extending from the hub 160. In one embodiment, the flange 166 includes a smooth radius R extending from the hub 160 to the flange 166. In one embodiment, the radius R curves tangentially away from an edge 168 of the hub 160, where the edge 168 is elevated above W1 by a distance A and recessed relative to the tape winding surface 162 by a distance B. In one embodiment, the distance A is about 0.0070 inches and the distance B is about 0.0013 inches, although dimensions for the offset edge 168 defined by distances A and B are also acceptable. In one embodiment, the radius R has a ray of about 0.020 inches and smoothly blends between the tape winding surface 162 and the flange 166.

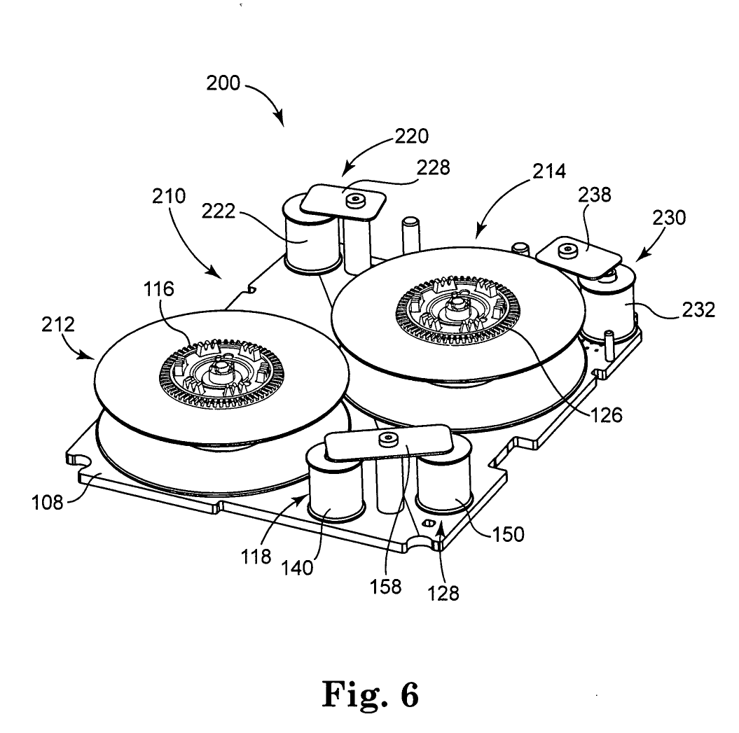

FIG. 6 is a perspective view of a tape system 200 according to another embodiment. The tape system 200 includes a tape guiding system 210 having components that are disposed on the base plate 108 and configured for insertion into a data storage tape cartridge or other storage device. The tape guiding system 210 includes rotating/static guide assemblies 118, 128 in the back guide positions and rotating/static guide assemblies 220, 230 in the front guide positions, where the guide assemblies include guides that define a bi-level tape path for data storage tape (not shown). In this regard, the tape system 200 is similar to the tape system 100, but includes rotating/static guide assemblies at both the front guide and back/idler guide positions.

In one embodiment, the tape guiding system 210 includes supply components 212 including the supply reel 116, the guide assembly 118, and a rotating/static front guide assembly 220, and the take-up components 214 include the take-up reel 126, the rotating/static guide assembly 128, and a front rotating/static guide assembly 230. The supply components 212 are disposed on a common first plane of the base plate 108, and the take-up components 214 are disposed on a common second plane of the base plate 108, where the first plane is different than the second plane such that the supply components 212 are uniformly offset from the take-up components 214.

In one embodiment, the guide assembly 220 is a rotating/static guide assembly including a startup-only guide 220 coupled to the base plate 108 by a sleeve and a pin (not shown) and retained in place by a retainer plate 228. In a similar manner, one embodiment of the guide assembly 230 includes a guide 232 coupled to the base plate 108 by a sleeve and a pin (not shown) and is held in place by a retainer plate 238. In one embodiment, the retainer plates 228, 238 are configured to adjust the tension of the guides 222, 232 by adjusting a preload force setting that is applied to a top face of the guides 222, 232. In this manner, the tension drop at which rotation of the guides 222, 232 stops may be adjusted.

Embodiments of the rotating/static guide assemblies 118, 128 in the back guide positions and/or rotating/static guide assemblies 220, 230 in the front guide positions have indicated a 30% reduction in start-up tension drop on idler members and a 17% reduction in start-up tension drop on front guide members. Thus, the rotating/static guide assemblies 118, 128, 220, 230 provide a desired start-up tension drop for the tape 33 while providing a static guide during operational speeds of the tape 33.

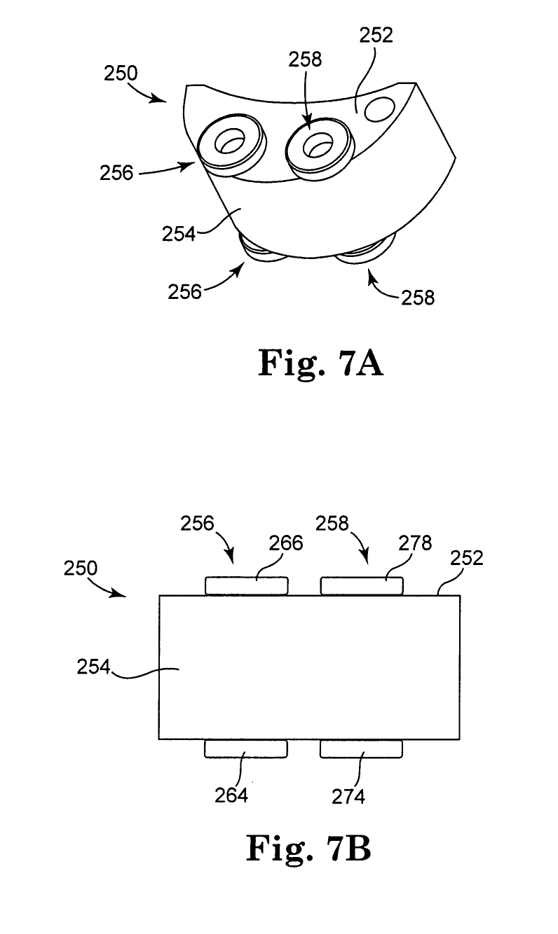

FIGS. 7A-7B illustrate a double flange guide assembly 250 configured for use with the tape guiding systems 30, 110, 210 described above. With additional reference to FIGS. 1 and 4, in one embodiment the front guides 40, 50 on either side of the read/write head 24 are replaced with a double flange guide assembly 250. In one embodiment, the double flange guide assembly 250 includes a body 252 that defines a tape surface 254, a first pair 256 of opposing flanges, and a second pair 258 of opposing flanges.

FIG. 7B is a front view of the double flange guide assembly 250. The first pair 256 of opposing flanges includes a bottom flange 264 and a top flange 266 opposite the bottom flange 264, and the second pair 258 of opposing flanges includes a bottom flange 274 and a top flange 278 opposite the bottom flange 274. The first and second pairs of opposing flanges 256, 258 provide closely spaced flanges 266 and 278 along the top and closely spaced flanges 264, 274 along the bottom of the assembly 250 that combine to gently transition the tape 33 from one common plane to the other common plane of the bi-level tape path.

In one embodiment, the body 252 is formed from a metal, such as stainless steel. In one embodiment, the first pair 256 of opposing flanges and the second pair 258 of opposing flanges include circular discs coupled to the body 252 in a stationary manner. In one embodiment, the flanges 264, 266 and 274, 278 are disposed at a right angle relative to the tape surface 254. Suitable materials for forming flanges 264, 266 and 274, 278 include tool steel or ceramic.

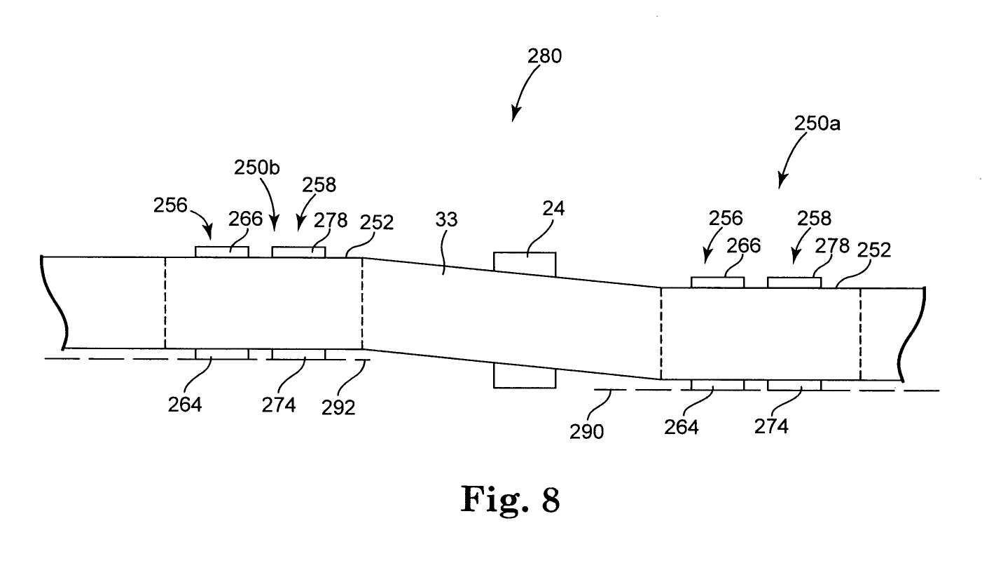

FIG. 8 is a front view of a tape path defined by the data storage tape 33 traversing between two double flange guide assemblies 250a, 250b. With reference to FIG. 1, one embodiment of a tape guiding system 280 provides a first double flange guide assembly 250a provided as a front guide on a first side of the head 24 and a second double flange guide assembly 250 provided as a front guide on a second side of the head 24. The back guides or idler guides 38, 48 (FIGS. 1-2) are not shown in FIG. 8 for ease of illustration. For example, one embodiment of the tape guiding system 280 replaces the front guides 40, 50 of FIG. 2 with double flange guide assemblies 250a, 250b.

In one embodiment, the first double flange guide assembly 250a is disposed on a first common plane 290, and the second double flange guide assembly 250b is disposed on a second common plane 292 to provide the tape 33 with a bi-level tape path consistent with the disclosure above. The four flanges 264, 266 and 274, 278 of the first double flange guide assembly 250a direct the tape 33 from a path aligned with the first common plane 290 up and across the head 24 to the second common plane 292. The pair of opposing flanges 256, 258 of each guide assembly 250a, 250b combine to minimize the edge force applied to the tape 33 and gently direct the tape 33 along the bi-level tape path defined by planes 290, 292.

In one embodiment, the first common plane 290 is uniformly offset from the second common plane 292 by a distance of between about 0.002-0.010 inches to provide the tape 33 with a bi-level tape path having a reduced standard deviation for tracking errors associated with closed looped tracking of servo patterns to less than about 100 nanometers.

Embodiments of the tape guiding systems 30, 110, 210, and 280 described above provide improved data storage tape tracking having a standard deviation in the residual tracking error of less than 100 nanometers.

Embodiments of the tape guiding systems 30, 110, 210, and 280 provide for the reduced standard deviation of tracking errors associated with closed looped tracking of servo patterns to less than about 100 nanometers. The improved tracking enables the recorded servo patterns to have improved linearity on the tape, which enables improved closed looped tracking during readout.

The magnetic tape industry employs an evaluation of open looped guiding by reading a servo signal (measuring tape motion) with a sensor without moving the servo head or the servo actuator. A reasonable closed loop servo tracking response can be simulated by passing the open looped signal through a second order pass filter. One suitable equation for the second order high passed filter is:

FilterOutput(s)=[s²/(s²+(s*(ωₙ/(Q+(ωₙ²))))]

Where s is the complex frequency in cycles per meter, ω is the natural frequency, and Q is a unitless damping factor. Reasonable values for ω and Q for tape systems are 60 cycles per meter and 1.333, respectively. Using these values, a suppression curve is developed and the closed loop response is statistically analyzed.

The standard deviation of the closed loop tracking can be used as a measure of performance. A typical range of values for the standard deviation of the closed loop tracking is approximately 200 to 500 nanometers for modern tape transports with the capability of supporting up to 1500 tracks per inch. Under the embodiments of this disclosure described above, the standard deviation of the closed loop tracking has been consistently demonstrated at less than about 100 nanometers, which would support up to 3,000 tracks per inch (1181 tracks per cm). According, aspects of embodiments enable the storage capacity of magnetic tape to double, based solely on guiding improvements during servo writing and servo readout. The improved guiding allows for servo tracks (and therefore the data tracks) to have improved linearity parallel to the tape edge.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of a bi-level tape path for data storage tape as discussed herein. Therefore, it is intended that this invention be limited only by the claims and the equivalents thereof.

What is claimed is:

1. A data storage tape guiding system configured to guide a data storage tape along a tape path crossing a read/write head, the data storage tape guiding system comprising:
data storage tape supply components disposed on a first side of the read/write head, an entirety of the supply components disposed on a common first plane; and
data storage tape take-up components disposed on a second side of the read/write head, an entirety of the take-up components disposed on a common second plane;
wherein the common first plane is different than the common second plane.

2. The data storage tape guiding system of claim 1, wherein the data storage tape supply components comprise a supply reel configured to maintain multiple wrappings of the data storage tape and at least one guide disposed between the supply reel and the read/write head.

3. The data storage tape guiding system of claim 2, wherein the supply reel comprises a hub and a lower flange that is disposed co-planar with the common first plane.

4. The data storage tape guiding system of claim 2, wherein the at least one guide comprises a fixed flange guide having a tape surface, a top flange coupled to the tape surface, and a bottom flange coupled to the tape surface opposite the top flange, the bottom flange disposed co-planar with the common first plane.

5. The data storage tape guiding system of claim 2, wherein the at least one guide comprises a rotating/static guide assembly configured to rotate upon start up acceleration of the storage tape and configured to be non-rotating when a speed of the storage tape reaches steady state.

6. The data storage tape guiding system of claim 2, wherein the at least one guide comprises a stationary dual flange guide assembly.

7. The data storage tape guiding system of claim 1, wherein the data storage tape take-up components comprise a take-up reel configured to maintain multiple wrappings of the data storage tape and at least one guide disposed between the take-up reel and the read/write head.

8. The data storage tape guiding system of claim 7, wherein the take-up reel comprises a hub and a lower flange, the lower flange disposed co-planar with the common second plane.

9. The data storage tape guiding system of claim 7, wherein the at least one guide comprises a fixed flange guide having a tape surface, a top flange coupled to the tape surface, and a bottom flange coupled to the tape surface opposite the top flange, the bottom flange disposed co-planar with the common second plane.

10. The data storage tape guiding system of claim 7, wherein the at least one guide comprises a rotating/static guide assembly configured to rotate upon start up acceleration of the storage tape and configured to be non-rotating when a speed of the storage tape reaches steady state.

11. The data storage tape guiding system of claim 7, wherein the at least one guide comprises a stationary dual flange guide assembly.

12. The data storage tape guiding system of claim 1, wherein the supply components comprise at least one supply guide and the take-up components comprise at least one take-up guide, each supply guide and each take-up guide comprising a cylindrical tape surface, top flange coupled to the cylindrical tape surface, and a bottom flange coupled to the cylindrical tape surface opposite the top flange, the top flange including a web defining a radius connecting with the cylindrical tape surface and the bottom flange including a web defining a radius connecting with the cylindrical tape surface.

13. The data storage tape guiding system of claim 1, wherein a bottom side of the read/write head is oriented on a reference plane, and the common first plane defines a first datum plane disposed above the reference plane and the common second plane defines a second datum plane disposed below the reference plane.

14. A data storage tape cartridge insertable into a tape drive having a read/write head, the data storage tape cartridge comprising:
a housing enclosing at least one reel maintaining a length of data storage tape; and
a guide system disposed on a base plate within the housing and including:
data storage tape supply components disposed on a first side of the read/write head, an entirety of the supply components aligned on a common first plane,
data storage tape take-up components disposed on a second side of the read/write head, an entirety of the take-up components aligned on a common second plane that is different than the common first plane;
wherein the guide system is configured to direct the data storage tape along a tape path extending from the common first plane, across the read/write head, to the common second plane.

15. The data storage tape cartridge of claim 14, wherein the data storage tape supply components and the data storage tape take-up components each comprise at least one rotating/static guide assembly configured to rotate upon start up acceleration of the storage tape and configured to be non-rotating when a speed of the storage tape reaches steady state.

16. The data storage tape cartridge of claim 14, wherein the data storage tape supply components and the data storage tape take-up components each comprise at least one stationary dual flange guide assembly.

17. The data storage tape cartridge of claim 14, wherein the base plate is fabricated such that the common first plane is offset from the common second plane by a distance of between about 0.002-0.010 inches.

18. A tape system comprising:
a data storage tape;
a read/write head configured to read data from and write data to the data storage tape; and
a guide system including:
an entirety of tape supply components aligned on a first common plane on a first side of the read/write head,
an entirety of tape take-up components aligned on a second common plane on a second side of the read/write head, the second common plane different than the first common plane;
wherein the guide system is configured to direct the data storage tape along a tape path extending from the first common plane, across read/write head, to the second common plane.

19. The tape system of claim 18, wherein the tape supply components and the tape take-up components each comprise at least one rotating/static guide assembly configured to rotate upon start up acceleration of the storage tape and configured to be non-rotating when a speed of the storage tape reaches steady state.

20. The tape system of claim 18, wherein the tape supply components and the tape take-up components each comprise at least one stationary dual flange guide assembly.
